(19) United States
(12) Patent Application Publication
(10) Pub. No.: US 2026/0242674 A1
(43) Pub. Date: Aug. 20, 2026

(54) ENHANCED RENEWABLE FEEDSTOCK CRACKING USING MODIFIED FCC CATALYSTS

(71) Applicant: CHEVRON U.S.A. INC., San Ramon, CA (US)

(72) Inventors: Joel Edward SCHMIDT, Oakland, CA (US); Tengfei LIU, Fairfield, CA (US)

(21) Appl. No.: 19/056,501

(22) Filed: Feb. 18, 2025

(51) Int. Cl. C10G 11/05

(52) U.S. Cl. CPC C10G 11/05; C10G 2300/1003; C10G 2300/1011; C10G 2400/20; C10G 2400/30

(57) ABSTRACT

A process for upgrading a renewable feedstock includes contacting the renewable feedstock with a cracking catalyst, where: the cracking catalyst comprises a ZSM-5 zeolite impregnated with iron, zinc, or both iron and zinc; and the contacting of the renewable feedstock with the cracking catalyst causes at least of portion of the renewable feedstock to undergo cracking reactions to produce a cracked effluent comprising light olefins, light aromatic compounds, or both.

### FIELD

The present disclosure generally relates to the catalytic cracking of renewable feedstocks. More specifically, the present disclosure relates to the catalytic cracking of renewable feedstocks to produce light olefins and/or light aromatics.

### BACKGROUND

The worldwide increasing demand for greater value petrochemical products and chemical intermediates remains a major challenge for many integrated refineries. In particular, the production of some valuable light olefins, such as ethylene and propylene, has attracted increased attention as pure olefin streams are considered the building blocks for polymer synthesis. Additionally, light aromatic compounds, such as benzene, toluene, and mixed xylenes can be useful as fuel blending constituents or can be converted to greater value chemical products and intermediates, which can be used as building blocks in chemical synthesis processes.

Renewable resources and bio-based feedstocks present a sustainable alternative to petrochemical sources. However, there is still a need for efficient methods that can process low-value biological feedstocks into high-value products.

### SUMMARY

In a first aspect, the present disclosure relates to a process for upgrading a renewable feedstock. The process comprises contacting the renewable feedstock with a cracking catalyst, where the cracking catalyst comprises a ZSM-5 zeolite impregnated with iron, zinc, or both iron and zinc; and the contacting of the renewable feedstock with the cracking catalyst causes at least of portion of the renewable feedstock to undergo cracking reactions to produce a cracked effluent comprising light olefins, light aromatic compounds, or both.

### DETAILED DESCRIPTION

The present disclosure is directed to catalytic cracking of a renewable feedstocks using a cracking catalyst to convert the renewable feedstocks to higher value hydrocarbon products, such as but not limited to light olefins, light aromatic compounds, or combinations of these.

### Definitions

As used in the present disclosure, the term “catalyst” refers to any substance that increases the rate of a specific chemical reaction, such as but not limited to cracking reactions.

As used in the present disclosure, the term “catalyst to oil ratio” or “CTO weight ratio” refers to the weight ratio of a catalyst to a process stream.

As used in the present disclosure, the term “cracking” refers to a chemical reaction where a molecule having carbon-carbon bonds is broken into more than one molecule by the breaking of one or more of the carbon-carbon bonds or a cyclic molecule having carbon-carbon bonds is converted to a non-cyclic molecule by the breaking or one or more of the carbon-carbon bonds. As used in the present disclosure, the term “catalytic cracking” refers to cracking conducted in the presence of a catalyst. Some catalysts may have multiple forms of catalytic activity, and calling a catalyst by one particular function does not render that catalyst incapable of being catalytically active for other functionality.

As used in the present disclosure, the term “effluent” refers to a stream that is passed out of a reactor, a reaction zone, or a separator following a particular reaction or separation. Generally, an effluent has a different composition than the stream that entered the reactor, reaction zone, or separator. It should be understood that when an effluent is passed to another component or system, only a portion of that effluent may be passed, unless otherwise stated. For example, a slipstream or bleed stream may carry some of the effluent away, meaning that only a portion of the effluent may enter the downstream component or system. The terms “reaction effluent” and “reactor effluent” particularly refer to a stream that is passed out of a reactor or a reaction zone.

As used in the present disclosure, the term “light aromatics” may refer to one or more compounds having an aromatic ring, with or without substitution, and from 6 to 8 carbon atoms, such as benzene, toluene, ethylbenzene, para-xylene, meta-xylene, and ortho-xylene.

As used in the present disclosure, the term “light olefins” refers olefins having from 2 to 4 carbon atoms, such as but not limited to ethylene, propylene, and butenes.

As used in the present disclosure, the term “reactor” refers to any vessel, container, conduit, or the like, in which one or more chemical reactions, such as but not limited catalytic cracking reactions, may occur between one or more reactants optionally in the presence of one or more catalysts. One or more “reaction zones” may be disposed within a reactor. The term “reaction zone” refers to a volume where a particular chemical reaction takes place in a reactor.

As used in the present disclosure, the terms “renewable feedstock”, “renewable feed”, and “material from renewable sources” mean a feedstock from a renewable source. A renewable source may be animal, vegetable, microbial, and/or bio-derived or mineral-derived waste materials suitable for the production of fuels, fuel components and/or chemical feedstocks.

As used in the present disclosure, the term “residence time” refers to the amount of time that reactants are in contact with a catalyst, at reaction conditions, such as at the reaction temperature.

As used in the present disclosure, “ZSM-5” refers to zeolites having an MFI framework type according to the IUPAC zeolite nomenclature and consisting of silica and alumina. ZSM-5 refers to “Zeolite Socony Mobil-5” and is a pentasil family zeolite that can be represented by the chemical formula NaₙAlₙSi₉₆₋ₙO₁₉₂·16H₂O, where 0<n<27.

### Cracking Catalyst

The cracking catalyst of the present disclosure can be used to convert renewable feedstocks to higher value products and intermediates, such as light olefins, light aromatic compounds, or both.

The cracking catalyst comprises, consists of, or consists essentially of a ZSM-5 zeolite impregnated with iron, zinc, or both iron and zinc.

The ZSM-5 zeolite may be active to catalytically crack hydrocarbonaceous compounds to produce smaller hydrocarbon molecules, such as the light olefins, light aromatic compounds, or both. The ZSM-5 zeolite can have a molar ratio of silica-to-alumina of greater than or equal to 10 or greater than or equal to 20. The ZSM-5 zeolite can have a molar ratio of silica-to-alumina of less than or equal to 300, such as less than or equal to 200, less than or equal to 100, or even less than or equal to 50. In embodiments, the ZSM-5 zeolite can have a molar ratio of silica-to-alumina of from 10 to 300, from 10 to 200, from 10 to 100, from 10 to 50, from 20 to 300, from 20 to 200, from 20 to 100, from 20 to 50, or from 50 to 300. The ZSM-5 zeolite can be in the form of a plurality of particles, such as a plurality of spherical particles. The ZSM-5 zeolite can be obtained from a commercial supplier or can be synthesized according to known methods of producing conventional microporous ZSM-5 zeolites.

The cracking catalyst may further include iron, iron-containing compounds, zinc, zinc-containing compounds, or combinations of these compounds impregnated onto the outer surfaces and pore surfaces of the ZSM-5 zeolite. The iron, iron-containing compounds, zinc, or zinc-containing compounds may be supported by the ZSM-5 zeolite. Not intending to be bound by any particular theory, it is believed that including iron, iron-containing compounds, zinc, or zinc-containing compounds in the cracking catalyst can improve the catalytic performance of the ZSM-5 zeolite. In embodiments, the iron-containing compounds may include iron oxide, such as FeO, Fe₂O₃, or Fe₃O₄. In embodiments, the zinc-containing compounds may include zinc oxide, such as ZnO₂. The iron, iron oxide, zinc, or zinc oxide may be disposed at or deposited on the outer surfaces, the pore surfaces, or both of the ZSM-5 zeolite so that the iron, iron oxide, zinc, or zinc oxide is accessible to reactants that come into contact with the cracking catalyst or diffuse into the pores of the cracking catalyst. The iron, iron oxide, zinc, or zinc oxide can be deposited on the ZSM-5 zeolite through known methods, such as but not limited to wet impregnation methods, incipient wetness impregnation methods, or other impregnation methods.

In embodiments, the cracking catalyst may comprise, consist of, or consist essentially of the ZSM-5 zeolite and from 0.1 wt. % to 35 wt. % of one or more of iron, iron-containing compounds, zinc, zinc-containing compounds, or combinations of these impregnated onto the ZSM-5 zeolite, where the weight percentage is based on the total weight of the cracking catalyst.

In embodiments, the ZSM-5 zeolite component of cracking catalyst can be impregnated with iron or iron oxide. In embodiments, the ZSM-5 zeolite component of the cracking catalyst can include one or more iron-containing compounds, such as but not limited to iron oxide, in an amount of from 0.1 wt. % to 35 wt. %, from 0.1 wt. % to 30 wt. %, from 0.1 wt. % to 25 wt. %, from 0.1 wt. % to 20 wt. %, from 0.1 wt. % to 15 wt. %, from 0.1 wt. % to 10 wt. %, from 0.1 wt. % to 5 wt. %, from 0.1 wt. % to 3 wt. %, from 1 wt. % to 30 wt. %, from 1 wt. % to 25 wt. %, from 1 wt. % to 20 wt. %, from 1 wt. % to 15 wt. %, from 1 wt. % to 10 wt. %, from 1 wt. % to 5 wt. %, or from 1 wt. % to 3 wt. % based on the total weight of the cracking catalyst.

In embodiments, the ZSM-5 zeolite component of cracking catalyst can be impregnated with zinc or zinc oxide. In embodiments, the ZSM-5 zeolite component of the cracking catalyst can include one or more zinc-containing compounds, such as but not limited to zinc oxide, in an amount of from 0.1 wt. % to 35 wt. %, from 0.1 wt. % to 30 wt. %, from 0.1 wt. % to 25 wt. %, from 0.1 wt. % to 20 wt. %, from 0.1 wt. % to 15 wt. %, from 0.1 wt. % to 10 wt. %, from 0.1 wt. % to 5 wt. %, from 0.1 wt. % to 3 wt. %, from 1 wt. % to 30 wt. %, from 1 wt. % to 25 wt. %, from 1 wt. % to 20 wt. %, from 1 wt. % to 15 wt. %, from 1 wt. % to 10 wt. %, from 1 wt. % to 5 wt. %, or from 1 wt. % to 3 wt. % based on the total weight of the cracking catalyst.

The cracking catalyst can include an amount of phosphorous-containing compounds, such as phosphorous pentoxide, sufficient- to improve the thermal stability of the cracking catalyst. In embodiments, the cracking catalyst may comprise from 0.1 wt. % to 5 wt. % phosphorus-containing compounds, such as but not limited to phosphorus pentoxide, based on the total weight of the cracking catalyst. In embodiments, the cracking catalyst may comprise from 1 wt. % to 5 wt. %, from 1 wt. % to 4.5 wt. %, from 1 wt. % to 4 wt. %, from 1 wt. % to 3.5 wt. %, from 1 wt. % to 3 wt. %, from 1 wt. % to 2.5 wt. %, from 1 wt. % to 2 wt. %, from 1 wt. % to 1.5 wt. %, from 1.5 wt. % to 5 wt. %, from 2 wt. % to 5 wt. %, from 2.5 wt. % to 5 wt. %, from 3 wt. % to 5 wt. %, from 3.5 wt. % to 5 wt. %, from 4 wt. % to 5 wt. %, from 4.5 wt. % to 5 wt. %, from 1.5 wt. % to 4.5 wt. %, from 2 wt. % to 4 wt. %, or from 2.5 wt. % to 4 wt. % phosphorous-containing compounds based on the total weight of the cracking catalyst.

In embodiments, the cracking catalyst does not include any binders, matrix materials, or other catalytic species supported on the ZSM-5 zeolite except the impregnated metal species (i.e., iron and/or zinc).

In embodiments, the cracking catalyst can be incorporated into composite catalyst particles the ZSM-5 zeolite impregnated metal oxides combined with one or more non-zeolitic inorganic materials and a matrix material and then formed into catalyst particles. The composite catalyst particles can include from 20 wt. % to 60 wt. % cracking catalyst (ZSM-5 zeolite impregnated with iron and/or zinc) based on the total weight of the composite catalyst particles. In embodiments, the composite catalyst particles may comprise from 20 wt. % to 55 wt. %, from 20 wt. % to 50 wt. %, from 20 wt. % to 45 wt. %, from 20 wt. % to 40 wt. %, from 30 wt. % to 60 wt. %, from 30 wt. % to 55 wt. %, from 30 wt. % to 50 wt. %, from 30 wt. % to 45 wt. %, from 40 wt. % to 60 wt. %, from 40 wt. % to 55 wt. %, or from 40 wt. % to 50 wt. % cracking catalyst based on the total weight of the composite catalyst particles.

In embodiments, the composite catalyst particles can include non-zeolitic inorganic materials, such as but not limited to non-zeolitic inorganic binders, non-zeolitic fillers, or both. The composite catalyst particles can include from 15 wt. % to 60 wt. % non-zeolitic inorganic materials based on the total weight of the composite catalyst particles. In embodiments, the composite catalyst particles can comprise from 15 wt. % to 20 wt. %, from 15 wt. % to 30 wt. %, from 15 wt. % to 40 wt. %, from 15 wt. % to 50 wt. %, from 20 wt. % to 30 wt. %, from 20 wt. % to 40 wt. %, from 20 wt. % to 50 wt. %, from 20 wt. % to 60 wt. %, from 30 wt. % to 40 wt. %, from 30 wt. % to 50 wt. %, from 30 wt. % to 60 wt. %, from 40 wt. % to 50 wt. %, from 40 wt. % to 60 wt. %, or from 50 wt. % to 60 wt. % non-zeolitic inorganic materials based on the total weight of the composite catalyst particles.

The non-zeolitic inorganic materials can include silica-based materials or alumina-based materials. Non-zeolitic inorganic materials can include, but are not limited to, one or more of silica sol, water glass (sodium silicate), silicic acid liquid, basic aluminum chloride, aluminum biphosphate, alumina sol, activated alumina, porous silica, or combinations of these. In embodiments, the non-zeolitic inorganic materials can include non-zeolitic inorganic oxides such as but not limited to activated alumina, porous silica, rare-earth metal oxides, or combinations of these.

In embodiments, the non-zeolitic inorganic materials can include an alumina binder. One example of an alumina binder can include but is not limited to CATAPAL™ B alumina available from Sasol Chemicals. In embodiments, the composite catalyst particles can include a peptized alumina binder. The alumina binder can be peptized by forming a mixture comprising the alumina binder, water, and a peptizing agent, such as but not limited to formic acid, and stirring the mixture for a time period sufficient to produce the peptized alumina binder. In embodiments, the composite catalyst particles can include from 15 wt. % to 60 wt. % of the peptized alumina binder based on the total weight of the composite catalyst particles. In embodiments, the composite catalyst particles can comprise from 15 wt. % to 20 wt. %, from 15 wt. % to 30 wt. %, from 15 wt. % to 40 wt. %, from 15 wt. % to 50 wt. %, from 20 wt. % to 30 wt. %, from 20 wt. % to 40 wt. %, from 20 wt. % to 50 wt. %, from 20 wt. % to 60 wt. %, from 30 wt. % to 40 wt. %, from 30 wt. % to 50 wt. %, from 30 wt. % to 60 wt. %, from 40 wt. % to 50 wt. %, from 40 wt. % to 60 wt. %, or from 50 wt. % to 60 wt. % of the peptized alumina binder based on the total weight of the composite catalyst particles.

The composite catalyst particles can comprise one or more matrix materials. As used in this disclosure, “matrix materials” refers to a clay material such as kaolin, which are also non-zeolitic materials. Without being bound by theory, it is believed that the matrix materials of the composite catalyst particles can serve both physical and catalytic functions. Physical functions include providing particle integrity and attrition resistance, acting as a heat transfer medium, and providing a porous structure to allow diffusion of hydrocarbons into and out of the composite catalyst particles. The matrix material can also affect catalyst selectivity, product quality, and resistance to poisons. In embodiments, the matrix material comprises kaolin. As used in this disclosure, “kaolin” refers to a clay material that has a relatively large amount (such as at least about 50 wt. %, at least 60 wt. %, at least 70 wt. %, at least 80 wt. %, at least 90 wt. %, or even at least 95 wt. %) of kaolinite, which can be represented by the chemical formula Al₂Si₂O₅(OH)₄. In additional embodiments, the matrix material may comprise other clay materials.

The composite catalyst particles comprising the cracking catalyst can include one or more matrix materials in an amount of from 20 wt. % to 60 wt. % based on the total weight of the composite catalyst particles. In embodiments, the composite catalyst particles can comprise from 20 wt. % to 55 wt. %, from 20 wt. % to 50 wt. %, from 20 wt. % to 45 wt. %, from 20 wt. % to 40 wt. %, from 30 wt. % to 60 wt. %, from 30 wt. % to 55 wt. %, from 30 wt. % to 50 wt. %, from 30 wt. % to 45 wt. %, from 40 wt. % to 60 wt. %, or from 40 wt. % to 50 wt. % matrix material based on the total weight of the composite catalyst particles. In embodiments, the composite catalyst particles can include any single disclosed matrix material in an amount of the disclosed weight percentage ranges. In embodiments, the composite catalyst particles can include any two or more matrix materials in combination in an amount of the disclosed weight percentage ranges.

The composite catalyst particles can be prepared by preparing a slurry comprising water, matrix materials, non-zeolitic inorganic materials such as a peptized alumina binder, and the cracking catalyst comprising the ZSM-5 zeolite impregnated with iron, zinc or iron and zinc. The slurry can then be spray dried and calcined (e.g., at a temperature of about 550° C. for about 6 hours) to produce the composite catalyst particles. In embodiments, the composite catalyst particles may have an average particle size of from 20 micrometers to 100 micrometers.

### Renewable Feedstock

A preferred class of renewable feedstocks are bio-renewable fats and oils comprising triglycerides, diglycerides, monoglycerides, free fatty acids, and/or fatty acid esters derived from bio-renewable fats and oils. Examples of fatty acid esters include, but are not limited to, fatty acid methyl esters and fatty acid ethyl esters. The bio-renewable fats and oils include both edible and non-edible fats and oils. Examples of bio-renewable fats and oils include, without limitation, algal oil, brown grease, canola oil, carinata oil, castor oil, coconut oil, colza oil, corn oil, cottonseed oil, fish oil, hempseed oil, jatropha oil, lard, linseed oil, milk fats, mustard oil, olive oil, palm oil, peanut oil, rapeseed oil, sewage sludge, soy oils, soybean oil, sunflower oil, tall oil, tallow, train oil, used cooking oil, yellow grease, and combinations thereof.

Another preferred class of renewable materials are liquids derived from biomass and waste liquefaction processes. Examples of such liquefaction processes include, but are not limited to, (hydro)pyrolysis, hydrothermal liquefaction, plastics liquefaction, and combinations thereof. Renewable materials derived from biomass and waste liquefaction processes may be used alone or in combination with bio-renewable fats and oils.

The renewable materials to be used as feedstock in the process of the present disclosure may contain impurities. Examples of such impurities include, but are not limited to, solids, iron, chloride, phosphorus, alkali metals, alkaline-earth metals, polyethylene and unsaponifiable compounds. If required, these impurities can be removed from the renewable feedstock before being introduced to the process of the present disclosure. Methods to remove these impurities are known to the person skilled in the art.

The process of the present disclosure is most particularly advantageous in the processing of feed streams comprising substantially 100% renewable feedstocks. However, in embodiments, renewable feedstock may be co-processed with petroleum-derived hydrocarbons. Petroleum-derived hydrocarbons include, without limitation, all fractions from petroleum crude oil, natural gas condensate, tar sands, shale oil, synthetic crude, and combinations thereof. The present disclosure is more particularly advantageous for a combined renewable and petroleum-derived feedstock comprising a renewable feed content in a range of from 30 wt. % to 99 wt. %.

### Catalytic Cracking

In the process of the present disclosure the renewable feedstock is subjected to catalytic cracking in a catalytic cracking reactor to obtain a cracking effluent comprising light olefins, light aromatics, or combinations of these.

The catalytic cracking reactor may comprise one or more fixed bed reactors, fluid bed reactors, batch reactors, fluid catalytic cracking (FCC) reactors, moving bed catalytic cracking reactors, or combinations of these. In embodiments, the catalytic cracking reactor is an FCC reactor. The FCC reactor may be a fluidized bed reactor. The FCC reactor may be an upflow or a downflow FCC reactor. The FCC reactor system can include one or a plurality of FCC reactors, with one or a plurality of catalyst regenerators.

The catalytic cracking step of the present disclosure may be performed at a temperature from 300° C. to 700° C., such as from 330° C. to 550° C. The processing temperature refers to the temperature at the process inlet. An exemplary temperature is 330° C. to 470° C. The residence time may be from 0.2 s to 7200 s. The catalytic cracking process conditions comprise typically a pressure from 1 bar to 40 bar.

According to one embodiment, catalytic cracking is performed at a temperature from 330° C. to 550° C., such as from 430° C. to 470° C., or about 450° C., with a residence time from 2 min to 2 h. These conditions are particularly suitable for, e.g., moving bed cracking process.

According to another embodiment, catalytic cracking is performed at a temperature from 300° C. to 550° C. such as from 430° C. to 470° C., or at about 450° C., with a residence time from 30 minutes to 2 h. These conditions are particularly suitable for, e.g., fixed bed cracking processes.

According to yet another embodiment catalytic cracking is performed at a higher temperature, i.e., from 450° C. to 700° C., such as from 600° C. to 670° C., or about 650° C., with a residence time from 0.2 s to 10 s. These conditions are particularly suitable for, e.g., an FCC reactor.

The catalytic cracking process may be performed without any added hydrogen, such as molecular hydrogen, to enhance the cracking over hydrogen associated reactions. However, a minor amount of hydrogen may result from the reactions taking place during cracking.

Alternatively, the cracking process may be performed in the presence of an inert gas, such as nitrogen, CO₂, steam, thereby decreasing the partial pressure of the product gases and thus influencing on, e.g., the coking. According to an exemplary embodiment, the catalytic cracking is performed in the presence of nitrogen flow.

An exemplary pressure when using an inert gas may be around the atmospheric pressure, i.e., at about 1 bar, or slightly above. The WHSV may be from 1 h⁻¹ to 10 h⁻¹, such as from 2 h⁻¹ to 5 h⁻¹.

In catalytic cracking a carbon-rich by-product, namely coke, is typically formed from hydrocarbons and deposited on the used catalyst surface. The formed coke gradually leads to deactivation of the catalyst. A coked catalyst is typically regenerated by burning off the coke with air. Depending on reactor type used, this regeneration may be done offline or online.

The catalytic cracking effluent may include one or more products and intermediates, such as but not limited to fuel gas, such as methane; saturated C2 to C4 hydrocarbons; light olefins; naphtha (C5-221° C.), which may include light aromatic compounds; light cycle oil (LCO, 221-343° C.); heavy cycle oil (HCO, 343° C.+), such as but not limited to slurry oil; or combinations of these. The light olefins in the steam catalytic cracking effluent may include ethylene, propylene, butenes, or combinations of these. The light aromatic compounds in the catalytic cracking effluent may include benzene, toluene, xylenes, ethylbenzene, or combinations of these.

In embodiments, the contacting the renewable feedstock with the cracking catalyst under catalytic cracking conditions may cause at least 60 wt. %, such as at least 65 wt. %, at least 70 wt. %, at least 75 wt. %, at least 80 wt. %, at least 85 wt. %, at least 90 wt. %, or at least 95 wt. % of the renewable feedstock to be converted to other products, based on the total weight of the renewable feedstock.

### Separation

The effluent from the catalytic cracking, i.e., the catalytically cracked stream is separated into different fractions using known separation methods. The catalytic cracking effluent may be removed from the used reactor via an overhead line, cooled and sent to fractionation, such as a fractionator tower, for recovering of the various cracking products. The recovery may be conducted in several steps.

The recovery may comprise one or more of distilling, fractionating, evaporating, flash-separating, membrane separating, extracting, using extractive-distillation, using chromatography, using molecular sieve adsorbents, using thermal diffusion, complex forming, crystallizing, preferably at least fractionating and distilling. Recovery may comprise multiple unit operations in succession.

In embodiments, the cracked effluent may be separated into fractions of which at least two are recovered as products, namely (i) a fraction comprising light olefins, and (ii) a fraction comprising light aromatics.

The recovered fractions may be subject to one or more further purification and/or fractionation steps. The optional purification and/or fractionation steps or treatments may be selected depending on the intended end use and/or desired degree of purity of the recovered light olefins and light aromatics, and/or any other recovered cracking effluent fraction.

In embodiments, the uncracked feed and/or fractions not recovered for product purposes may be recycled back to catalytic cracking.

### EXAMPLES

The various aspects of the present disclosure will be further clarified by the following examples. The examples are illustrative in nature and should not be understood to limit the subject matter of the present disclosure.

### Example 1

### Cracking Catalyst Evaluation

Cracking catalysts comprising a commercial ZSM-5 additive and iron oxide or zinc oxide impregnated onto the catalyst particles were prepared by conventional means known in the art. The metal loadings for each of the cracking catalysts are provided in Tables 1-2.

The cracking catalysts were evaluated by conducting catalyst performance tests using an Advanced Cracking Evaluation (ACE) reactor. The reactor used for evaluation was an ACE-Model C Fluid Bed Microactivity unit from Kayser Technology, Inc.

The reactor employed in the ACE unit was a fixed fluidized reactor with 1.6 cm ID. Nitrogen was used as fluidization gas and introduced from both bottom and top. The top fluidization gas was used to carry the feed injected from a calibrated syringe feed pump via a three-way valve. The catalytic cracking of soybean oil was carried out at atmospheric pressure and temperatures from 850° F. to 1050° F. For each experiment, a constant amount of feed was injected at the rate of 1.2 g/min for 75 seconds. The catalyst/oil ratio was fixed at 6. After 75 seconds of feed injection, the catalyst was stripped off by nitrogen for a period of 525 seconds.

During the catalytic cracking and stripping process the liquid product was collected in a sample vial attached to a glass receiver, which was located at the end of the reactor exit and was maintained at −15° C. The gaseous products were collected in a closed stainless-steel vessel (12.6 L) prefilled with N₂ at 1 atm. Gaseous products were mixed by an electrical agitator rotating at 60 rpm as soon as feed injection was completed. After stripping, the gas products were further mixed for 10 minutes to ensure homogeneity. The final gas products were analyzed using a refinery gas analyzer (RGA).

After the completion of stripping process, in-situ catalyst regeneration was carried out in the presence of air at 1300° F. The regeneration flue gas passed through a catalytic converter packed with CuO pellets (LECO Inc.) to oxidize CO to CO₂. The flue gas was then analyzed by an online infrared (IR) analyzer located downstream the catalytic converter. Coke deposited during cracking process was calculated from the CO₂ concentrations measured by the IR analyzer.

Results of the cracking experiments of soybean oil are given in Table 1 and Table 2.

TABLE 1
Catalytic cracking of soybean oil over a ZSM-5 additive
impregnated with varying amounts of zinc

| | ZSM-5 | +1% | +5% | +10% | +20% | +30% |
|---|---|---|---|---|---|---|
| | additive | Zn | Zn | Zn | Zn | Zn |
| Conversion, | 92.72 | 94.29 | 93.96 | 94.29 | 91.29 | 88.31 |
| wt % | | | | | | |
| Yields, wt % | | | | | | |
| Coke | 1.26 | 1.20 | 1.61 | 2.83 | 3.67 | 3.91 |
| Dry Gas | 5.44 | 6.06 | 6.41 | 5.84 | 4.70 | 4.34 |
| Hydrogen | 0.06 | 0.32 | 0.90 | 0.91 | 0.53 | 0.38 |
| Methane | 0.28 | 0.42 | 0.71 | 0.75 | 0.67 | 0.69 |
| Ethane | 0.33 | 0.44 | 0.34 | 0.35 | 0.50 | 0.66 |
| Ethylene | 4.77 | 4.88 | 4.45 | 3.83 | 3.00 | 2.61 |
| LPG | 25.81 | 26.24 | 21.91 | 20.56 | 17.17 | 13.39 |
| Propane | 2.93 | 4.25 | 2.24 | 1.61 | 1.03 | 0.89 |
| Propylene | 11.03 | 10.71 | 10.03 | 9.59 | 8.24 | 6.39 |
| n-Butane | 0.93 | 1.24 | 0.79 | 0.63 | 0.47 | 0.42 |
| Isobutane | 1.15 | 1.62 | 1.17 | 0.88 | 0.36 | 0.23 |
| C4 Olefins | 9.76 | 8.42 | 7.67 | 7.86 | 7.07 | 5.46 |
| Standard cut | 47.30 | 46.69 | 50.17 | 52.06 | 52.47 | 53.71 |
| gasoline | | | | | | |
| (C5-430° F.) | | | | | | |
| LCO | 4.51 | 3.52 | 3.75 | 3.69 | 6.10 | 7.51 |
| (430-650° F.) | | | | | | |
| HCO | 2.77 | 2.19 | 2.29 | 2.02 | 2.60 | 4.17 |
| (650 F.+) | | | | | | |
| CO | 3.96 | 4.48 | 4.14 | 3.40 | 2.88 | 2.56 |
| CO₂ | 0.49 | 0.85 | 2.34 | 3.31 | 3.39 | 3.00 |
| H₂O | 8.46 | 8.77 | 7.38 | 6.29 | 7.01 | 7.39 |
| Gasoline n- | 1.05 | 0.67 | 0.49 | 1.55 | 2.79 | 3.32 |
| paraffins, | | | | | | |
| wt % | | | | | | |
| Gasoline | 5.01 | 5.00 | 5.19 | 5.36 | 7.50 | 6.46 |
| iso- | | | | | | |
| paraffins, | | | | | | |
| wt % | | | | | | |
| Gasoline | 86.89 | 90.85 | 92.38 | 90.64 | 79.41 | 75.57 |
| aromatics, | | | | | | |
| wt % | | | | | | |
| Gasoline | 1.18 | 0.48 | 0.28 | 0.28 | 1.56 | 2.88 |
| naphthenes, | | | | | | |
| wt % | | | | | | |
| Gasoline | 5.46 | 2.77 | 1.67 | 2.18 | 8.51 | 11.77 |
| olefins, wt % | | | | | | |
| RON-GC | 120.43 | 124.80 | 126.44 | 123.78 | 117.63 | 105.91 |
| MON-GC | 87.44 | 86.06 | 85.91 | 82.77 | 77.84 | 93.93 |
| (RON + | 103.94 | 105.43 | 106.18 | 103.28 | 97.74 | 99.92 |
| MON)/2 | | | | | | |
| Benzene | 4.40 | 10.48 | 10.60 | 5.01 | 4.22 | 3.02 |
| Toluene | 12.89 | 34.84 | 38.77 | 20.25 | 16.64 | 13.11 |
| Ethylbenzene | 3.15 | 6.08 | 5.57 | 2.96 | 2.74 | 2.75 |
| m-Xylene | 3.72 | 8.54 | 8.00 | 1.73 | 0.38 | 0.67 |
| p-Xylene | 7.37 | 15.68 | 15.65 | 11.63 | 11.43 | 11.04 |
| o-Xylene | 1.32 | 2.95 | 2.79 | 0.55 | 0.26 | 0.50 |
| Total | 12.41 | 27.17 | 26.44 | 13.91 | 12.07 | 12.21 |
| xylenes | | | | | | |
| % p-Xylene | 59% | 58% | 59% | 84% | 95% | 90% |
| % of C3═ | 79% | 72% | 82% | 86% | 89% | 88% |
| % of C4═ | 82% | 75% | 80% | 84% | 89% | 89% |
| Aromatics, | 41.10 | 42.42 | 46.34 | 47.18 | 41.67 | 40.59 |
| wt % of feed | | | | | | |
| C4═/C3═ | 0.89 | 0.79 | 0.76 | 0.82 | 0.86 | 0.85 |

TABLE 2
Catalytic cracking of soybean oil over a ZSM-5 additive
impregnated with varying amounts of iron

| | ZSM-5 | | | | |
|---|---|---|---|---|---|
| | additive | +1% Fe | +5% Fe | +20% Fe | +30% Fe |
| Conversion, | 92.72 | 94.17 | 89.11 | 94.23 | 95.08 |
| wt % | | | | | |
| Yields, wt % | | | | | |
| Coke | 1.26 | 1.58 | 2.83 | 6.96 | 14.60 |
| Dry Gas | 5.44 | 5.91 | 4.97 | 5.14 | 6.46 |
| Hydrogen | 0.06 | 0.06 | 0.05 | 0.26 | 0.58 |
| Methane | 0.28 | 0.27 | 0.32 | 0.34 | 0.53 |
| Ethane | 0.33 | 0.41 | 0.38 | 0.28 | 0.46 |
| Ethylene | 4.77 | 5.18 | 4.22 | 4.26 | 4.89 |
| LPG | 25.81 | 28.70 | 24.93 | 25.80 | 23.43 |
| Propane | 2.93 | 3.61 | 2.52 | 2.19 | 3.64 |
| Propylene | 11.03 | 12.47 | 11.21 | 12.02 | 9.96 |
| n-Butane | 0.93 | 1.13 | 0.86 | 0.77 | 1.15 |
| Isobutane | 1.15 | 1.38 | 0.90 | 0.83 | 1.38 |
| C4 Olefins | 9.76 | 10.11 | 9.44 | 9.98 | 7.31 |
| Standard cut | 47.30 | 44.66 | 43.31 | 43.04 | 37.04 |
| gasoline | | | | | |
| (C5-430° F.) | | | | | |
| LCO | 4.51 | 3.46 | 5.06 | 3.73 | 2.91 |
| (430-650° F.) | | | | | |
| HCO (650° F.+) | 2.77 | 2.37 | 5.82 | 2.04 | 2.01 |
| CO | 3.96 | 4.08 | 3.68 | 3.51 | 3.48 |
| CO₂ | 0.49 | 0.92 | 1.41 | 2.53 | 4.85 |
| H₂O | 8.46 | 8.32 | 7.99 | 7.25 | 5.22 |
| Gasoline n- | 1.05 | 1.04 | 1.63 | 3.41 | 2.26 |
| paraffins, | | | | | |
| wt % | | | | | |
| Gasoline | 5.01 | 5.40 | 4.96 | 6.70 | 5.06 |
| Iso- | | | | | |
| paraffins, | | | | | |
| wt % | | | | | |
| Gasoline | 86.89 | 86.89 | 82.28 | 77.64 | 88.40 |
| aromatics, | | | | | |
| wt % | | | | | |
| Gasoline | 1.18 | 0.83 | 1.17 | 2.10 | 0.64 |
| naphthenes, | | | | | |
| wt % | | | | | |
| Gasoline | 5.46 | 5.36 | 8.95 | 9.93 | 3.59 |
| olefins, wt % | | | | | |
| RON-GC | 120.43 | 121.06 | 110.50 | 114.81 | 119.24 |
| MON-GC | 87.44 | 87.28 | 95.09 | 79.48 | 83.24 |
| (RON + MON)/2 | 103.94 | 104.17 | 102.80 | 97.15 | 101.24 |
| Benzene | 4.40 | 8.09 | 6.50 | 2.64 | 2.78 |
| Toluene | 12.89 | 30.99 | 25.66 | 10.89 | 12.34 |
| Ethylbenzene | 3.15 | 7.01 | 6.93 | 2.97 | 2.50 |
| m-Xylene | 3.72 | 4.60 | 0.00 | 1.32 | 1.92 |
| p-Xylene | 7.37 | 21.21 | 25.35 | 9.45 | 9.04 |
| o-Xylene | 1.32 | 1.63 | 0.62 | 0.55 | 0.75 |
| Total | 12.41 | 27.44 | 25.97 | 11.32 | 11.72 |
| xylenes | | | | | |
| % of PX | 59% | 77% | 98% | 83% | 77% |
| % of C3═ | 79% | 78% | 82% | 85% | 73% |
| % of C4═ | 82% | 80% | 84% | 86% | 74% |
| Aromatics, | 41.10 | 38.80 | 35.63 | 33.41 | 32.74 |
| wt % of feed | | | | | |
| C4═/C3═ | 0.89 | 0.81 | 0.84 | 0.83 | 0.73 |

The results in Tables 1-2 show that conversion is maintained even up to 30 wt. % Zn or Fe.

As shown in Table 1, increasing Zn content in the ZSM-5 additive resulted in an increase in gasoline olefins as gasoline aromatics decrease, an increase in total gasoline, a decrease in C3 and C4 olefins, an increase in coke formation, and stable total xylenes content while the percentage of para-xylene increased significantly showing an improvement in shape selectivity.

As shown in Table 2, increasing Fe content in the ZSM-5 additive resulted in an increase in gasoline olefins as gasoline aromatics decrease, an increase in total gasoline, a decrease in C3 and C4 olefins, an increase in coke formation, and stable total xylenes content while the percentage of para-xylene increased significantly showing an improvement in shape selectivity.

As shown in Table 2, increasing Fe content in the ZSM-5 additive resulted in a significant increase in coke formation, a decrease in total gasoline, and an increase and then a decrease in gasoline aromatics (with the opposite trend for gasoline olefins), in C3 and C4 olefins, and in total xylenes (with the percentage of para-xylene following the same trend).

### Example 2

### Effect of Steaming on Catalytic Cracking

In this example, catalyst compositions with 5 wt. % metal loadings were steam treated at 800° C. for 24 hours to simulate an aged catalyst that had undergone severe steam deactivation. Results are reported in Table 3. The results show that there is remarkably little change in activity after deactivation. In the zinc sample, the percentage of para-xylene increases while it only decreases slightly in the iron sample. Under the severe deactivation conditions studied here, the results suggest the long-term stability of these metal-exchanged catalyst additives for catalytic cracking of renewable feeds.

TABLE 3

| Catalyst | ZSM-5 | | +5% Zn + | | +5% Fe + |
|---|---|---|---|---|---|
| Name | additive | +5% Zn | steamed | +5% Fe | steamed |
| Conversion, | 92.72 | 93.96 | 90.18 | 89.11 | 92.15 |
| wt % | | | | | |
| Cat/Oil, | 6.00 | 6.00 | 6.00 | 6.00 | 6.00 |
| wt/wt | | | | | |
| Yields, wt % | | | | | |
| Coke | 1.26 | 1.61 | 1.89 | 2.83 | 4.04 |
| Dry Gas | 5.44 | 6.41 | 3.43 | 4.97 | 4.39 |
| Hydrogen | 0.06 | 0.90 | 0.09 | 0.05 | 0.07 |
| Methane | 0.28 | 0.71 | 0.22 | 0.32 | 0.24 |
| Ethane | 0.33 | 0.34 | 0.18 | 0.38 | 0.20 |
| Ethylene | 4.77 | 4.45 | 2.94 | 4.22 | 3.88 |
| LPG | 25.81 | 21.91 | 24.88 | 24.93 | 25.70 |
| Propane | 2.93 | 2.24 | 0.49 | 2.52 | 0.92 |
| Propylene | 11.03 | 10.03 | 12.25 | 11.21 | 12.82 |
| n-Butane | 0.93 | 0.79 | 0.26 | 0.86 | 0.40 |
| Isobutane | 1.15 | 1.17 | 0.28 | 0.90 | 0.50 |
| C4 Olefins | 9.76 | 7.67 | 11.59 | 9.44 | 11.06 |
| Standard cut | 47.30 | 50.17 | 46.26 | 43.31 | 44.31 |
| gasoline | | | | | |
| (C5-430° F.) | | | | | |
| LCO | 4.51 | 3.75 | 6.03 | 5.06 | 4.86 |
| (430-650° F.) | | | | | |
| HCO (650° F.+) | 2.77 | 2.29 | 3.79 | 5.82 | 2.99 |
| CO | 3.96 | 4.14 | 3.42 | 3.68 | 3.67 |
| CO₂ | 0.49 | 2.34 | 0.61 | 1.41 | 0.68 |
| H₂O | 8.46 | 7.38 | 9.69 | 7.99 | 9.37 |
| Gasoline n- | 1.05 | 0.49 | 5.40 | 1.63 | 4.08 |
| Paraffins, | | | | | |
| wt % | | | | | |
| Gasoline | 5.01 | 5.19 | 10.11 | 4.96 | 6.43 |
| Iso- | | | | | |
| paraffins, | | | | | |
| wtg | | | | | |
| Gasoline | 86.89 | 92.38 | 61.82 | 82.28 | 72.59 |
| aromatics, | | | | | |
| wt % | | | | | |
| Gasoline | 1.18 | 0.28 | 4.51 | 1.17 | 2.94 |
| naphthenes, | | | | | |
| wt % | | | | | |
| Gasoline | 5.46 | 1.67 | 15.68 | 8.95 | 12.60 |
| olefins, wt % | | | | | |
| RON-GC | 120.43 | 126.44 | 100.05 | 110.50 | 105.13 |
| MON-GC | 87.44 | 85.91 | 85.92 | 95.09 | 90.09 |
| (RON + MON)/2 | 103.94 | 106.18 | 92.99 | 102.80 | 97.61 |
| Benzene | 4.40 | 10.60 | 1.65 | 6.50 | 1.80 |
| Toluene | 12.89 | 38.77 | 6.49 | 25.66 | 8.17 |
| Ethylbenzene | 3.15 | 5.57 | 2.96 | 6.93 | 3.22 |
| m-Xylene | 3.72 | 8.00 | 1.24 | 0.00 | 0.83 |
| p-Xylene | 7.37 | 15.65 | 6.68 | 25.35 | 9.27 |
| o-Xylene | 1.32 | 2.79 | 0.58 | 0.62 | 0.47 |
| Total | 12.41 | 26.44 | 8.50 | 25.97 | 10.58 |
| xylenes | | | | | |
| % p-Xylene | 59% | 59% | 79% | 98% | 88% |
| C3═/C3 | 79% | 82% | 96% | 82% | 93% |
| C4═/C4 | 82% | 80% | 95% | 84% | 92% |
| Aromatics, | 41.10 | 46.34 | 28.60 | 35.63 | 32.16 |
| wt % of feed | | | | | |
| C4═/C3═ | 0.89 | 0.76 | 0.95 | 0.84 | 0.86 |

The foregoing examples demonstrate that two abundant and economical metals can be used to improve the performance of renewable feed cracking using ZSM-5 FCC additives. Significantly, these metal-exchanged catalysts can impact the selectivity to valuable products such as light olefins and para-xylene. Furthermore, these metal-exchanged catalysts are very resistant to even the severe deactivation conditions studied here.

1. A process for upgrading a renewable feedstock, the process comprising contacting the renewable feedstock with a cracking catalyst, where:
the cracking catalyst comprises a ZSM-5 zeolite impregnated with iron, zinc, or both iron and zinc; and
the contacting of the renewable feedstock with the cracking catalyst causes at least of portion of the renewable feedstock to undergo cracking reactions to produce a cracked effluent comprising light olefins, light aromatic compounds, or both.

2. The process of claim 1, wherein the renewable feedstock is selected from the group consisting of one or more bio-renewable fats and oils, liquid derived from a biomass liquefaction process, liquid derived from a waste liquefaction process, and combinations thereof.

3. The process of claim 1, where the ZSM-5 zeolite has a molar ratio of silica-to-alumina of from 20 to 300.

4. The process of claim 1, wherein the ZSM-5 zeolite is impregnated with from 1 wt. % to 30 wt. % iron oxide, based on a total weight of the cracking catalyst.

5. The process of claim 1, wherein the ZSM-5 zeolite is impregnated with from 1 wt. % to 30 wt. % zinc oxide, based on a total weight of the cracking catalyst.

6. The process of claim 1, wherein phosphorous is present in the cracking catalyst as phosphorous pentoxide, and the cracking catalyst comprises from 0.1 wt. % to 5 wt. %. phosphorus pentoxide based on the total weight of the cracking catalyst.

7. The process of claim 1, comprising contacting the renewable feedstock oil in the presence of a plurality of composite catalyst particles, where the plurality of composite catalyst particles comprises the cracking catalyst, an inorganic binder, and a matrix material.

8. The process of claim 7, where the composite catalyst particles comprise from 20 wt. % to 60 wt. % of the cracking catalyst, from 15 wt. % to 60 wt. % of the inorganic binder, and from 20 wt. % to 60 wt. % of the matrix materials based on the total weight of the composite catalyst particles.

9. The process of claim 7, where the matrix material comprises kaolin clay and the inorganic binder comprises peptized alumina.

10. The process of claim 1, comprising contacting the renewable feedstock with the cracking catalyst in a cracking reactor, where the cracking reactor comprises one or more of fixed bed reactors, fluid bed reactors, batch reactors, fluid catalytic cracking (FCC) reactors, moving bed catalytic cracking reactors, or combinations of these.

11. The process of claim 1, further comprising adding a petroleum-derived feedstock for co-processing with the renewable feedstock, preferably in an amount to produce a feed stream comprising from 30 wt. % to 99 wt. % renewable feedstock.

12. The process of claim 1, further comprising separating the cracked effluent into a fraction comprising light olefins and/or a fraction comprising light aromatics.
